(19) United States
(12) Patent Application Publication
(10) Pub. No.: US 2011/0285869 A1
(43) Pub. Date: Nov. 24, 2011

(54) SERIAL DATA SENDING AND RECEIVING APPARATUS AND DIGITAL CAMERA

(75) Inventor: Hideyuki YOSHIDA, Fukuoka (JP)

(73) Assignee: PANASONIC CORPORATION, Osaka (JP)

(21) Appl. No.: 13/198,192

(22) Filed: Aug. 4, 2011

Related U.S. Application Data
(63) Continuation of application No. PCT/JP2009/006556, filed on Dec. 2, 2009.

(30) Foreign Application Priority Data
Feb. 27, 2009 (JP) 2009-047009

(51) Int. Cl. H04N 7/01; H04N 5/225

(52) U.S. Cl. 348/222.1; 348/441; 348/E07.003; 348/E05.024

(57) ABSTRACT

A serial data sending and receiving apparatus includes a sending unit and a receiving unit. The sending unit includes an inserting unit carrying out iterative insertion of inserting, between each of adjacent pairs of line data, a piece of determining information. Each of the adjacent pairs of the line data found in successively arranged pieces of the line data is included in serial image data. The sending unit includes a data format converting unit sending a receiving unit, via the transmission path, information-inserted serial image data with a plurality of pieces of determining information inserted. The receiving unit includes a determining unit sequentially detecting the pieces of the determining information from the information-inserted serial image data received from the transmission path, and determining whether or not non-reproducible line data is found according to at least part of the detected pieces of the determining information.

### CROSS REFERENCE TO RELATED APPLICATION

This is a continuation application of PCT application No. PCT/JP2009/006556 filed on Dec. 2, 2009, designating the United States of America.

### BACKGROUND OF THE INVENTION

(1) Field of the Invention

The present invention relates to a serial data sending and receiving apparatus which transmits serial-format data, and to a digital camera.

(2) Description of the Related Art

Recent solid-state imaging apparatuses for digital still cameras and digital video cameras have had a larger amount of image data to be processed. Thus, in these days, more and more solid-state imaging apparatuses are equipped with circuits using Low Voltage Differential Signaling (LVDS)-based signals which make possible high-speed data processing.

Patent Literature 1 (Japanese Unexamined Patent Application Publication No. 2005-086224) discloses a solid-state imaging apparatus using differential signals as LVDS signals. Described hereinafter is a solid-state imaging apparatus using differential signals.

FIG. 5 shows a conventional solid-state imaging apparatus 500 using a differential signal.

The solid-state imaging apparatus 500 shown in FIG. 5 includes a solid-state imaging device 11, an Analog Front-End (AFE) unit 100, a data format converting unit 513, a transmitting unit 14, and a data format converting unit 515.

The solid-state imaging device 11 captures an image of an object, and obtains an analog image signal. The obtained analog image signals represent one frame.

The AFE unit 100 is capable of analog-to-digital (A/D) conversion. In the A/D conversion, an analog signal is converted into a digital signal. Hereinafter, the A/D conversion is processing in which the analog signal is converted into the digital signal.

The AFE unit 100 includes an image processing unit 12, and a Timing Generator (TG) 101.

The image processing unit 12 performs an A/D conversion on an analog image signal according to a low-speed clock SCLK, and obtains digitalized image data (hereinafter referred to as digital image data). The obtained digital image data is image data for one frame. The description below regards the image data as image data for one frame.

The obtained digital image data includes two or more pieces of line data. When the size of an image reproduced from the digital image data is, for example, 1280 pixels wide and 760 pixels long, the digital image data includes 760 pieces of line data.

Moreover, the obtained digital image data includes two or more pieces of pixel data. The pixel data is represented in N (for example, 24) bit. Furthermore, the obtained digital image data is parallel-format image data (hereinafter referred to as parallel image data).

Here the parallel image data is to be sent to the data format converting unit 513 for each piece of pixel data (N-bit data). When N is “24”, for example, the image processing unit 12 and the data format converting unit 513 are connected with 24 data lines.

Here the image processing unit 12 sends the parallel image data to the data format converting unit 513 for each piece of pixel data (N-bit data).

The data format converting unit 513 converts parallel-format data into serial-format data (hereinafter parallel-to-serial conversion). The parallel-to-serial conversion is carried out according to a high-speed clock FCLK. The data format converting unit 513 carries out the parallel-to-serial conversion on the parallel image data, and obtains serial-format image data (hereinafter referred to as serial image data).

It is noted that the data format converting unit 513 inserts after-described synchronization code in the serial image data. Hence the serial image data includes the synchronization code.

FIGS. 6A and 6B depict the serial image data including synchronization codes.

FIG. 6A depicts serial image data including synchronization codes.

The serial image data includes the line data LD1, LD2, . . . , LDv (v: positive integer). When the size of the image obtained from the serial image data is 1280 pixels wide and 760 pixels long, the serial image data includes 760 pieces of line data.

Moreover, each piece of the line data LD1, LD2, . . . , LDv includes u (positive integer) pieces of pixel data. When the width of the image obtained from the serial image data has 1280 pixels, each piece of the line data LD1, LD2, . . . , LDv includes 1280 pieces of pixel data. For example, 1280 pieces of the pixel data are pieces of pixel data P11, P12, . . . P1u.

In FIG. 6A, a synchronization code SOF indicates the start of the frame. A synchronization code EOL indicates the end of each piece of line data. A synchronization code SOL indicates the start of each piece of line data. A synchronization code EOF indicates the end of the frame. Each of the synchronization codes SOF, EOF, EOL, and SOL includes two or more bits. Moreover, a unique value, which does not correspond to the pixel data, is set to each of the synchronization codes SOF, EOF, EOL, and SOL.

FIG. 6B depicts a structure of the serial image data shown in FIG. 6A in conformity with the shape of the image obtained from the serial image data.

As shown in FIG. 6B, the synchronization code SOL is added to the start of each piece of the line data, except to the start of the line data LD1. The synchronization code SOF is added to the start of the line data LD1. The synchronization code EOL is added to the end of each piece of the line data, except to the end of the line data LDv. The synchronization code EOF is added to the end of the line data LDv.

With reference to FIG. 5 again, the TG 101 generates a vertical synchronizing signal VSC and a horizontal synchronizing signal HSC. The vertical synchronizing signal VSC is used for defining the start of an image as a frame. The horizontal synchronizing signal HSC is used for defining the start or the end of each of the lines forming an image as a frame.

The TG 101 sends each of the generated vertical synchronizing signal VSC and horizontal synchronizing signal HSC to each of the solid-state imaging device 11, the image processing unit 12, and the data format converting unit 513 with corresponding and predetermined timing.

The transmitting unit 14 includes transmission paths 14D and 14C.

The data format converting unit 513 and the data format converting unit 515 are electrically connected with each other via the transmission paths 14D and 14C. Each of the transmission paths 14D and 14C is used for transmitting serial data on the LVDS signal.

Each of the transmission paths 14D and 14C includes a twisted-pair wire having two lines. The transmission path 14D transmits the serial-format data on the LVDS signal. The transmission path 14C transmits the clock FCLK on the LVDS signal.

The data format converting unit 513 uses the transmission path 14D to send the data format converting unit 515 the serial image data with the synchronization codes inserted as shown in FIG. 6A. The data format converting unit 513 uses the transmission path 14C to send the data format converting unit 515 the clock FCLK. In response to the clock FCLK sent from the transmission path 14C, the data format converting unit 515 converts the serial-format data into parallel-format data (hereinafter referred to as serial-to-parallel conversion). The data format converting unit 515 carries out the serial-to-parallel conversion on the received serial image data, and obtains a parallel image data.

It is noted that, when carrying out the serial-to-parallel conversion, the data format converting unit 515 detects the synchronization codes SOF and EOF included in the serial image data, and synchronizes a frame with a corresponding piece of serial image data. When carrying out the serial-to-parallel conversion, the data format converting unit 515 detects the synchronization codes EOL and SOL, and synchronizes the pieces of the line data with each other.

Then, the data format converting unit 515 sends the parallel image data to another external circuit (not shown) for each piece of pixel data (N-bit data).

Furthermore, the data format converting unit 515 sends the received clock FCLK to an external circuit. Upon every detection of any one of the synchronization codes SOF, EOF, EOL, and SOL, moreover, the data format converting unit 515 sends the external circuit the detected synchronization code.

### SUMMARY OF THE INVENTION

Hereinafter, the transmission path for transmitting the serial data is referred to as a serial transmission path. The serial transmission path is, for example, the transmission paths 14D and 14C in FIG. 5.

Here, consider the case where the serial transmission path is affected by noise, and the data undergoes a change before going through the serial transmission path (hereinafter referred to as pre-transmission data) and after going through the serial transmission path (hereinafter referred to as transmitted data). Assumed, for example, is that the synchronization code SOL or the synchronization code EOL to be included in the serial image data is missing. The serial image data is the transmitted data.

Here, the line data corresponding to the missing synchronization code cannot be reproduced (decoded). In other words, when the receiver, which received the serial image data, reproduces the serial image data to obtain an image, the obtained image is missing a line corresponding to the missing synchronization code. Hence the receiver which received the serial image data obtains non-reproducible line data.

The conventional technique cannot detect such non-reproducible line data.

The present invention is conceived in view of the above problem and has an object to provide a serial data sending and receiving apparatus which is capable of detecting non-reproducible line data.

In order to solve the above problem, a serial data sending and receiving apparatus according to an aspect of the present invention includes: a sending unit which sends serial-format data via a transmission path; and a receiving unit which receives the serial-format data via the transmission path. The sending unit includes a data format converting unit which converts parallel-format image data including a plurality of pieces of line data into serial image data which is serial-format image data. The serial image data includes the pieces of the line data which are successively arranged. The sending unit further includes an inserting unit which carries out iterative insertion of inserting, between each of adjacent pairs of the line data, a piece of determining information for determining whether or not non-reproducible line data is found, each of the adjacent pairs of the line data found in the successively arranged pieces of the line data included in the serial image data. By the inserting unit carrying out the repetitive inserting processing, the data format converting unit (i) obtains information-inserted serial image data which is serial-format data, and has each of a plurality of pieces of determining information inserted into the serial image data, and (ii) sends the obtained information-inserted serial image data to the receiving unit via the transmission path. The receiving unit includes a determining unit which sequentially detects the pieces of the determining information from the information-inserted serial image data received from the transmission path, and determines whether or not the non-reproducible line data is found according to at least part of the detected pieces of the determining information.

The sending unit includes the inserting unit which carries out iterative insertion of inserting, between each of adjacent pairs of the line data, a piece of determining information for determining whether or not non-reproducible line data is found, each of the adjacent pairs of the line data found in the successively arranged pieces of the line data included in the serial image data. The data format converting unit sends the receiving unit the information-inserted serial image data having a plurality of pieces of determining information inserted via the transmission path. The receiving unit includes the determining unit which sequentially detects the pieces of the determining information from the information-inserted serial image data received from the transmission path, and determines whether or not the non-reproducible line data is found according to at least part of the detected pieces of the determining information.

Thus, the presence of the non-reproducible line data can be detected.

Preferably, each piece of determining information indicates a value for specifying corresponding one of the pieces of the line data, and the determining unit (i) sequentially detects the pieces of the determining information from the information-inserted serial image data, and (ii) compares a value indicated in a detected most recent piece of the determining information with a value indicated in a piece of the determining information detected immediately before the most recent piece of the determining information to determine whether or not the non-reproducible line data is found.

Thus, the presence of the non-reproducible line data can be detected.

Preferably, the inserting unit carries out the iterative insertion for (i) inserting first determining information as the determining information between an n-th (n: positive integer) adjacent pair of the line data in the successively arranged pieces of the line data, and (ii) inserting second determining information, as the determining information, between an n+1-th adjacent pair of the line data in the successively arranged pieces of the line data.

Preferably, the determining unit included in the receiving unit (i) sequentially detects the pieces of the determining information from the information-inserted serial image data, and, in the case where detected and successive two of the pieces of the determining information are both one of the first determining information and the second determining information, and (ii) determines that the non-reproducible line data is found.

Preferably, at least one of the first determining information and the second determining information is indicated in one-bit data.

Thus, the data amount of the alternatively-information-inserted serial image data, including the first determining information and the second determining information as the determining information, can be reduced.

Preferably, the serial data sending and receiving apparatus further includes a resending instructing unit which gives, in the case where the determining unit determines that the non-reproducible line data is found, the sending unit an instruction for re-sending, to the receiving unit, line data corresponding to the non-reproducible line data.

Thus, the line data corresponding to the non-reproducible line data can be obtained even in the case where the non-reproducible line data is found. Accordingly, a normal image can be reproduced.

Preferably, the transmission path transmits data on a Low Voltage Differential Signaling (LVDS)-based signal.

A digital camera according to another aspect of the present invention includes: the serial data sending and receiving apparatus; an imaging device which obtains an image signal by imaging an object; an analog front-end unit which obtains image data by converting the image signal obtained by the imaging device into digital data; an image processing unit which processes the image data; and a display unit which displays an image which is based on the image data processed by the image processing unit. The serial data sending and receiving apparatus obtains the image data from the analog front-end unit, and send the obtained image data to the image processing unit via the sending unit and the receiving unit.

It is noted that in the present invention, a part or all of the constituent elements constituting the serial data sending and receiving apparatus may be configured from a single System-LSI (Large-Scale Integration).

Moreover, the present invention may be provided as a serial data sending and receiving method including, as steps, operations of characteristic units included in the serial data sending and receiving apparatus. Furthermore, the present invention may be provided as a program to cause a computer to execute each of the steps included in the serial data sending and receiving method. In addition, the present invention may be provided as a non-transitory computer-readable recording medium which stores the program. The program may be distributed via a transmission medium, such as the Internet.

The present invention can detect the presence of non-reproducible line data.

### FURTHER INFORMATION ABOUT TECHNICAL BACKGROUND TO THIS APPLICATION

The disclosure of Japanese Patent Application No. 2009-047009 filed on Feb. 27, 2009 including specification, drawings and claims is incorporated herein by reference in its entirety.

The disclosure of PCT application No. PCT/JP2009/006556 filed on Dec. 2, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 depicts a structure of a solid-state imaging apparatus according to Embodiment 1;

FIG. 2A depicts information-inserted serial image data which includes a line code LC;

FIG. 2B depicts the information-inserted serial image data which includes the line code LC;

FIG. 3 shows a structure of a solid-state imaging apparatus according to Embodiment 2;

FIG. 4A shows an external view of a solid-state imaging apparatus as a digital still camera;

FIG. 4B shows an external view of a solid-state imaging apparatus as a digital video camera;

FIG. 5 shows a conventional solid-state imaging device using a differential signal;

FIG. 6A depicts serial image data including synchronization codes; and

FIG. 6B depicts the serial image data including the synchronization codes.

### DESCRIPTION OF THE PREFERRED EMBODIMENTS

Described hereinafter are the embodiments of the present invention with reference to the drawings. In the description below, the same constituent features share the same numerical references. The names and functions thereof are the same. Thus the details thereof shall not be repeated.

Furthermore, the embodiments described below are just examples. The description below regards the image data as image data for one frame.

### Embodiment 1

Embodiment 1 shows that determination information, as well as a synchronization code, is inserted between each of adjacent pairs of line data in order to detect non-reproducible line data.

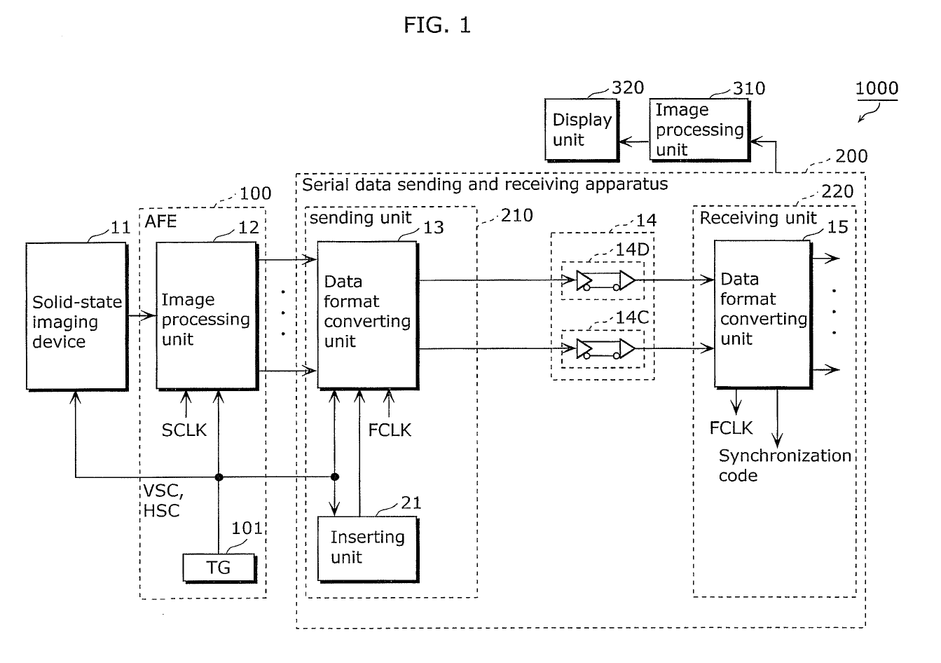

FIG. 1 shows a structure of a solid-state imaging apparatus 1000 according to Embodiment 1.

The solid-state imaging apparatus 1000 is a digital camera such as a digital still camera or a digital video camera.

The solid-state imaging apparatus 1000 shown in FIG. 1 includes a solid-state imaging device 11, an AFE unit 100, a serial data sending and receiving apparatus 200, an image processing unit 310, and a display unit 320.

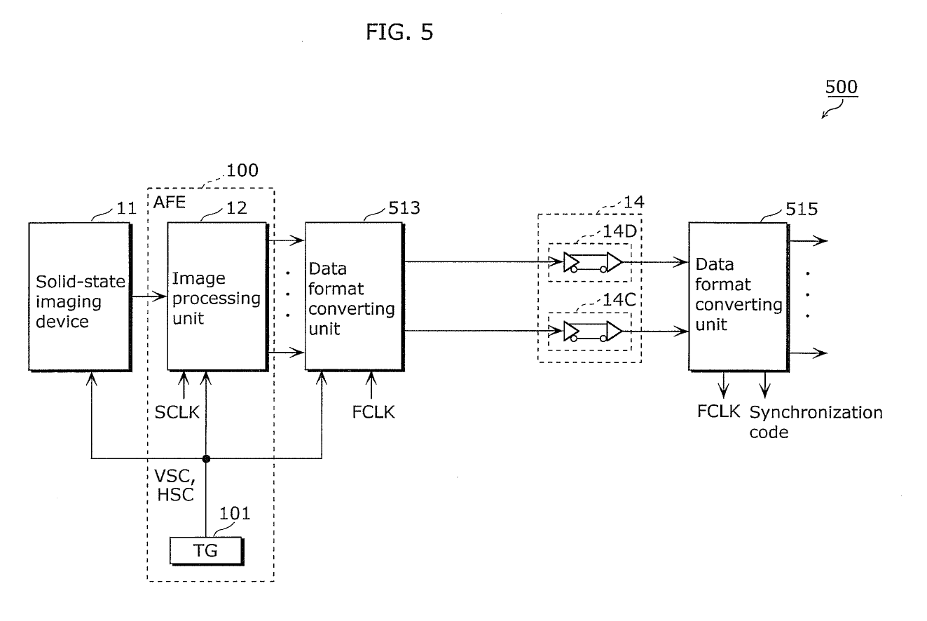

The solid-state imaging device 11 and the AFE unit 100 in FIG. 1 are respectively the solid-state imaging device 11 and the AFE unit 100 in FIG. 5. Thus the details thereof shall not be repeated.

The serial data sending and receiving apparatus 200 includes a sending unit 210, a transmitting unit 14, and a receiving unit 220.

Similar to the transmitting unit 14 in FIG. 5, the transmitting unit 14 in FIG. 1 includes transmission paths 14D and 14C. The transmission paths 14D and 14C have been described above, and thus the details thereof shall not be repeated.

The sending unit 210 includes a data format converting unit 13, and an inserting unit 21.

The image processing unit 12 in the AFE unit 100 sends parallel image data to the data format converting unit 13 for each piece of pixel data (N-bit data).

Similar to the data format converting unit 513 in FIG. 5, the data format converting unit 13 carries out parallel-to-serial conversion to convert parallel-format data into serial-format data. The parallel-to-serial conversion is carried out according to a high-speed clock FCLK. The data format converting unit 13 carries out the parallel-to-serial conversion on the parallel image data, and obtains serial image data.

It is noted that when carrying out the parallel-to-serial conversion, the data format converting unit 13 inserts a synchronization code into the serial image data as the data format converting unit 513 does so. Hence the serial image data includes the synchronization code. Hereinafter, the serial image data with the synchronization code inserted is referred to as code-added serial image data.

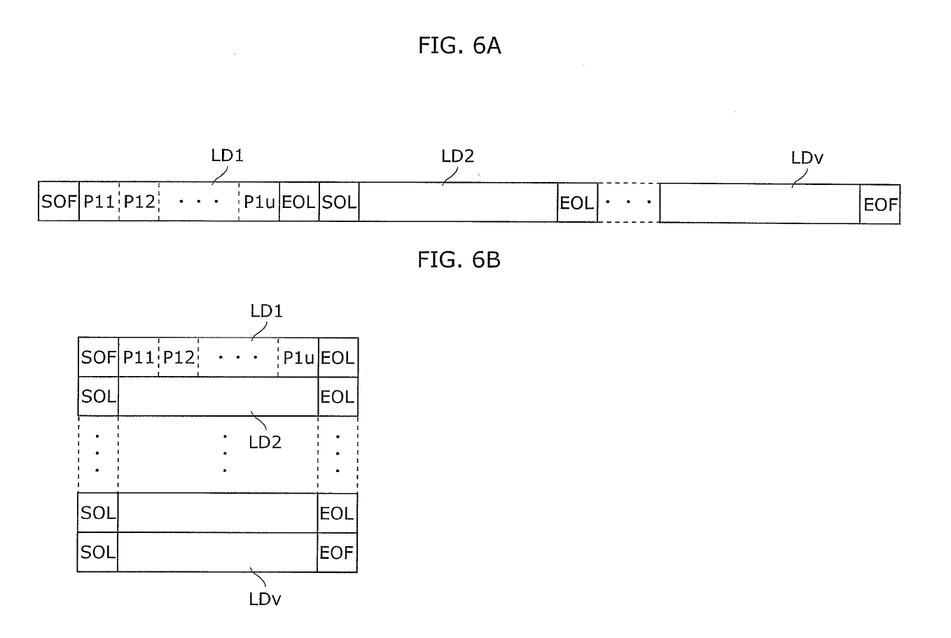

The code-added serial image data has a structure shown, for example, in FIG. 6A.

As described before, the TG 101 of the solid-state imaging apparatus 1000 according to Embodiment 1 sends each of a vertical synchronizing signal VSC and a horizontal synchronizing signal HSC to each of the solid-state imaging device 11, the image processing unit 12, the data format converting unit 13, and the inserting unit 21 with corresponding and predetermined timing. It is noted that the timing with which the vertical synchronizing signal VSC and the horizontal synchronizing signal HSC are transmitted is set according to a typical image processing technique. Thus the details thereof shall not be repeated.

Upon receiving the vertical synchronizing signal VSC, the inserting unit 21 sequentially receives two or more of the horizontal synchronizing signals HSC.

For every reception of the horizontal synchronizing signal HSC, the inserting unit 21 increments the value of a line counter by “1”. The line counter is used for counting the number of the pieces of the line data. The line counter has the default value of “0”. It is noted that, when receiving the vertical synchronizing signal VSC again after having received the vertical synchronizing signal VSC, the inserting unit 21 sets the value of the line counter to “0”.

Moreover, the inserting unit 21 generates a line code LC for each update of the value of the line counter. The line code LC is used for specifying line data.

For example, the code-added serial image data generated by the data format converting unit 13 is the data shown in FIG. 6A. Here the code-added serial image data includes v-pieces (v: positive integer) of line data.

In association with each of the v-pieces of line data included in the code-added serial image data, the inserting unit 21 generates a line code LC used for specifying a corresponding one of the v-pieces of the line data.

In FIG. 6A, for example, the line data LD1 is the first line data. Here the line code LC to be generated in association with the line data LD1 shows the value of the line counter whose value is changed after (i) the inserting unit 21 receives the vertical synchronizing signal VSC, and (ii) the inserting unit 21 receives the first horizontal synchronizing signal HSC. Here, in other words, the line code LC to be generated in association with the line data LD1 shows “1”.

Then, upon generating each of line codes LC, the inserting unit 21 carries out inserting processing. In the inserting processing, the inserting unit 21 sends the generated line code LC and an inserting instruction to the data format converting unit 13.

The inserting instruction is used for inserting the line code LC between the synchronization code EOL and the synchronization code SOL. Here the synchronization code EOL is added to the end of the w-th (w: positive integer) piece of the line data. The synchronization code SOL is added to the start of the w+1-th piece of the line data. Both of the w-th line data and the w+1-th line data are specified by the line code LC to be sent, and found in the successive pieces of the line data included in the code-added serial image data.

In other words, the inserting instruction is used for inserting the line code LC between each of adjacent pairs of the line data included in successive pieces of the line data.

Upon receiving the line code LC and the inserting instruction, the data format converting unit 13 inserts the line code LC into the code-added serial image data according to the inserting instruction. It is noted that when receiving an inserting instruction which corresponds to the line data LDv shown in FIG. 6A, the data format converting unit 13 does not insert the line code LC.

In carrying out the inserting processing, the inserting unit 21 causes the data format converting unit 13 to insert the line code LC between each of adjacent pairs of the line data found in successive pieces of the line data included in the code-added serial image data. In other words, the inserting processing involves causing the data format converting unit 13 to insert the line code LC between the each of adjacent pairs of the line data found in successive pieces of the line data included in the code-added serial image data.

Once the inserting processing is repeated by the inserting unit 21 as many times as the number of the pieces of the line data included in the code-added serial image data, the inserting processing carried out on the code-added serial image data ends. When the inserting processing carried out on the code-added serial image data ends, the data format converting unit 13 obtains a code-added serial image data including the line codes LC (hereinafter referred to as information-inserted serial image data).

Hereinafter, repeating the inserting processing as many times as the number of the pieces of the line data included in the code-added serial image data is referred to as iterative insertion. In other words, the inserting unit 21 carries out the iterative insertion by repeating the inserting processing as many times as the number of the pieces of the line data included in the code-added serial image data.

The iterative insertion involves causing the data format converting unit 13 to insert each line code LC between corresponding one of adjacent pairs of the line data found in the successive pieces of the line data included in the code-added serial image data.

Hence when the inserting unit 21 carries out the iterative insertion on the code-added serial image data, the data format converting unit 13 inserts the line code LC between corresponding one of adjacent pairs of the line data found in the successive pieces of the line data included in the code-added serial image data. Thus the data format converting unit 13 obtains the information-inserted serial image data.

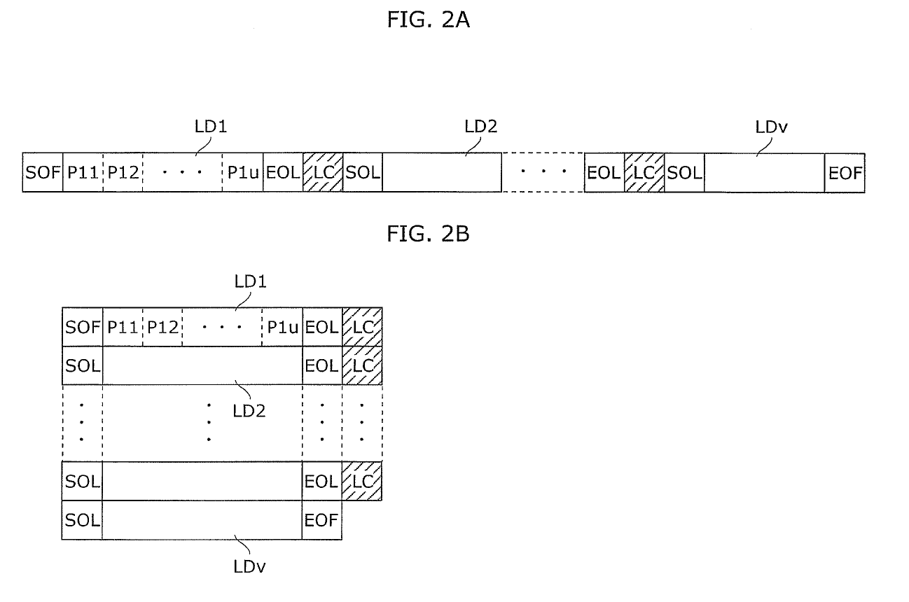

FIGS. 2A and 2B depict the information-inserted serial image data which includes line codes LC.

FIG. 2A depicts the code-added serial image data with the line codes LC inserted.

As shown in FIG. 2A, for example, a line code LC is inserted between the synchronization code EOL added to the end of the first line data LD1 and the synchronization code SOL added to the start of the second line data LD2.

For example “1” is the line code LC between the synchronization code EOL added to the end of the first line data LD1 and the synchronization code SOL added to the start of the second line data LD2. The line code LC indicating “1” is used for specifying the line data LD1. In addition, for example, the line code LC indicating “v (positive integer)-1” is used for specifying line data LD (v−1).

It is noted that the position into which the line code LC is inserted is between each of adjacent pairs of the line data in a horizontal blanking interval. Thus inserting the line code LC does not affect quality of the image to be reproduced from the information-inserted serial image data.

FIG. 2B depicts the structure of the information-inserted serial image data shown in FIG. 2A in conformity with the shape of the image obtained from the information-inserted serial image data.

When the number of the pieces of the line data is v as shown in FIG. 2B, the number of the line codes LC included in the information-inserted serial image data is (v−1).

In FIG. 2B, the line code LC shown on the right of each row corresponds to the line data of an associated row. In FIG. 2B, for example, the line code LC on the first row corresponds to the line data LD1. For example, the line code LC on the second row corresponds to the line data LD2.

With reference to FIG. 1 again, the receiving unit 220 includes a data format converting unit 15.

The data format converting unit 13 and the data format converting unit 15 are electrically connected with each other via the transmission paths 14D and 14C. The transmission paths 14D and 14C have been described before, and thus the details thereof shall be omitted.

The data format converting unit 13 uses the transmission path 14D to send the data format converting unit 15 the information-inserted serial image data with the line code LC-inserted as shown in FIG. 2A.

The data format converting unit 13 uses the transmission path 14C to send the data format converting unit 15 the clock FCLK. Similar to the data format converting unit 515 in FIG. 5, the data format converting unit 15 carries out the serial-to-parallel conversion to convert the serial-format data into parallel-format data according to the clock FCLK to be received via the transmission path 14C. The data format converting unit 15 carries out the serial-to-parallel conversion on the information-inserted serial image data, and obtains a parallel image data.

In addition, similar to the data format converting unit 515 in FIG. 5, the data format converting unit 15 detects the synchronization codes SOF, EOL, SOL, and EOF included in the information-inserted serial image data, when carrying out the parallel-to-serial conversion.

When carrying out the serial-to-parallel conversion, the data format converting unit 15 sequentially detects the two or more of the line codes LC included in the information-inserted serial image data.

Upon every detection of the line code LC, the data format converting unit 15 carries out determination processing. In the determination processing, the data format converting unit 15 determines whether or not the value (hereinafter referred to as most recent line value) indicated in the detected most recent line code LC is greater by one than the value (hereinafter referred to as previous line value) indicated in the line code LC detected immediately before the specified most recent line code LC.

It is noted that the data format converting unit 15 does not carry out the determination processing when detecting the first line code LC.

When determining that the most recent line value is greater than the previous line value by one, the data format converting unit 15 determines that the line data corresponding to the detected most recent line code LC is reproducible (decodable).

Concurrently, when determining that the most recent line value is not greater than the previous line value by one, the data format converting unit 15 determines that the line data corresponding to the detected most recent line code LC is non-reproducible (hereinafter referred to as non-reproducible line data). In other words, the data format converting unit 15 determines that the non-reproducible line data is found.

The data format converting unit 15 is a determining unit which determines whether or not the non-reproducible line data is found.

The line code LC also works as determining information used for determining whether or not the non-reproducible line data is found. The case below is where the data format converting unit 15 determines that the line data corresponding to the detected most recent line code LC is the non-reproducible line data. This occurs, for example, when noise develops in the transmission path 14D during a period in which the information-inserted serial image data is transmitted via the transmission path 14D, and, for example, the synchronization code SOL or the synchronization code EOL included in the information-inserted serial image data is missing.

Moreover, the data format converting unit 15 sends the image processing unit 310 the parallel-format image data obtained through the serial-to-parallel conversion for each piece of the pixel data (N-bit data).

The image processing unit 310 carries out various kinds of image processing on the received image data. Then the image processing unit 310 sends the display unit 320 the processed image data.

The display unit 320 is used for displaying an image. The display unit 320 displays an image which is based on the image data sent from the image processing unit 310.

As described above, Embodiment 1 involves sending the receiving unit 220 the information-inserted serial image data with the line code LC inserted between each of adjacent pairs of line data found in the successive pieces of the lined data included in the code-added serial image data.

The data format converting unit 15 in the receiving unit 220 sequentially detects two or more of line codes LC included in the received information-inserted serial image data.

Then, upon every detection of the line code LC, the data format converting unit 15 determines whether or not the non-reproducible line data is found by determining whether or not the most recent line value indicated in the most recent line code LC is greater by one than the previous line value indicated in the line code LC detected immediately before the most recent line code LC. In other words, in Embodiment 1, the non-reproducible line data is successfully specified.

It is noted that all or some of the solid-state imaging device 11, the image processing unit 12, the data format converting unit 13, the transmission paths 14D and 14C, the data format converting unit 15, and the inserting unit 21 may be formed in one-chip Large Scale Integration (LSI).

(Modification of Embodiment 1)

A solid-state imaging apparatus according to the modification of Embodiment 1 is the solid-state imaging apparatus 1000 in FIG. 1. Thus the detailed description of each of the units included in the solid-state imaging apparatus 1000 shall not be repeated.

In the modification according to Embodiment 1, the line code LC to be inserted into the code-added serial image data is one-bit data. Specifically, the modification according to Embodiment 1 differs from Embodiment 1 in that the inserting unit 21 generates a line code LC represented in one-bit data, and carries out processing for inserting the generated line code LC into the code-added serial image data. The processing other than the above is similar to that in Embodiment 1, and the detailed description thereof shall not be repeated.

Specifically, for every reception of the horizontal synchronizing signal HSC, the inserting unit 21 increments the value of the line counter by “1”.

Then, the inserting unit 21 generates the line code LC for each update of the value of the line counter. Specifically, the inserting unit 21 generates a line code LC indicating “0” when the value of the updated line counter is an odd number. Furthermore, the inserting unit 21 generates a line code LC indicating “1” when the value of the updated line counter is an even number.

Then, upon generating each of line codes LC, the inserting unit 21 carries out inserting processing “A”. In the inserting processing “A”, the inserting unit 21 sends the generated line code LC and an inserting instruction “A” to the data format converting unit 13.

The inserting instruction “A” is used for inserting the line code LC between the synchronization code EOL and the synchronization code SOL. Here the synchronization code EOL is added to the end of the w-th (w: positive integer) piece of the line data corresponding to the w-th line code LC to be transmitted. The synchronization code SOL is added to the start of the w+1-th piece of the line data. Both of the w-th line data and the w+1-th line data are found in the successive pieces of the line data included in the code-added serial image data. For example, the first line data corresponding to the first line code LC to be sent is line data LD1.

In other words, the inserting instruction “A” is used for inserting the line code LC between each of adjacent pairs of line data included in successive pieces of the line data.

Upon receiving the line code LC and the inserting instruction “A”, the data format converting unit 13 inserts the line code LC into the code-added serial image data according to the inserting instruction “A”. It is noted that when receiving an inserting instruction “A” which corresponds to the line data LDv shown in FIG. 6A, the data format converting unit 13 does not insert the line code LC.

Once the inserting processing “A” is repeated by the inserting unit 21 as many times as the number of the pieces of the line data included in the code-added serial image data, the inserting processing “A” carried out on the code-added serial image data ends. When the inserting processing “A” carried out on the code-added serial image data ends, the data format converting unit 13 obtains a code-added serial image data including the line codes LC (hereinafter referred to as alternatively-information-inserted serial image data).

Hereinafter, repeating the inserting processing “A” as many times as the number of the pieces of the line data included in the code-added serial image data is referred to as alternative inserting processing. In other words, the inserting unit 21 carries out the alternative inserting processing by repeating the inserting processing “A” as many times as the number of the pieces of the line data included in the code-added serial image data.

The alternative inserting processing involves causing the data format converting unit 13 to insert each line code LC between corresponding one of adjacent pairs of the line data found in the successive pieces of the line data included in the code-added serial image data. In other words, the alternative inserting processing is the above-described iterative insertion.

Hereinafter, the line code LC indicating “0” and the line code LC indicating “1” are respectively referred to as a first line code LC and a second line code LC. In addition, the first line code LC and the second line code LC are also respectively referred to as first determining information and second determining information.

In the modification, the inserting processing “A” is repeated as many times as the number of the pieces of the line data included in the code-added serial image data. Hence the alternatively-information-inserted serial image data having the data structure in FIG. 2A is generated.

Here, in two or more pieces of the line data included in the alternatively-information-inserted serial image data, for example, the line code LC between the first two neighboring line data LD1 and LD2 is the first line code LC. Moreover, in two or more pieces of the line data included in the alternatively-information-inserted serial image data, for example, the line code LC between the second two neighboring line data LD2 and LD3 is the second line code LC.

Specifically, in the modification in Embodiment 1, the inserting unit 21 carries out the above-described alternative inserting processing. The alternative inserting processing is iterative insertion for (i) inserting the first line code LC between the n-th adjacent pair of the line data found in two or more pieces of the line data included in the code-added serial image data, and (ii) inserting the second line code LC between the n+1-th adjacent pair of line data found in two or more pieces of the line data.

When the inserting unit 21 carries out the inserting processing “A” for sending the first line code LC and the inserting instruction “A” in the alternative inserting processing, the data format converting unit 13 inserts the first line code LC (first determining information) between the n-th adjacent pair of the line data found in two or more pieces of the line data included in the code-added serial image data.

When the inserting unit 21 carries out the inserting processing “A” for sending the second line code LC and the inserting instruction “A” in the alternative inserting processing, the data format converting unit 13 inserts the second line code LC (second determining information) between the n+1-th adjacent pair of the line data found in two or more pieces of the line data included in the code-added serial image data.

Hence, the data format converting unit 13 obtains the alternatively-information-inserted serial image data.

Through the transmission path 14D, the data format converting unit 13 sends the data format converting unit 15 the alternatively-information-inserted serial image data with the line code LC inserted as shown in FIG. 2A.

In the serial-to-parallel conversion, the data format converting unit 15 sequentially detects the two or more of the line codes LC included in the alternatively-information-inserted serial image data.

Upon every detection of the line code LC, the data format converting unit 15 carries out determination processing “A”. In the determination processing “A”, the data format converting unit 15 determines whether or not the most recent line value indicated in the detected most recent line code LC differs from the previous line value indicated in the line code LC detected immediately before the most recent line code LC.

It is noted that the data format converting unit 15 does not carry out the determination processing “A” when detecting the first line code LC.

When determining that the most recent line value differs from the previous line value, the data format converting unit 15 determines that the line data corresponding to the detected most recent line code LC is reproducible (decodable). Here, each of the two consecutive line codes LC indicating the most recent line value and the previous line value is the first line code LC and the second line code LC.

Concurrently, when determining that the most recent line value does not differ from the previous line value; that is the most recent line value is the same as the previous line value, the data format converting unit 15 determines that the line data corresponding to the detected most recent line code LC is non-reproducible (hereinafter referred to as non-reproducible line data). In other words, the data format converting unit 15 determines that the non-reproducible line data is found. Here, each of the two consecutive line codes LC indicating the most recent line value and the previous line value is the first line code LC and the second line code LC.

Specifically, the data format converting unit 15 as a determining unit sequentially detects two or more pieces of determining information (line codes LC) from the information-inserted serial image data (alternatively-information-inserted serial image data). When both of the detected two successive pieces of determining information (line codes LC) are either the first determining information (first line code LC) or the second determining information (second line code LC), the data format converting unit 15 determines that the non-reproducible line data is found.

As described above, the non-reproducible line data can be specified in the modification according to Embodiment 1, as well as in Embodiment 1. It is noted that in Embodiment 1, the line code LC is one-bit data. Thus, the data amount of the alternatively-information-inserted serial image data to be transmitted in the transmission path 14D can be made smaller. The resulting advantage is that a circuit for determining the presence or absence of the non-reproducible line data can be made smaller.

### Embodiment 2

Embodiment 2 shows processing to resend line data corresponding to non-reproducible line data when it is determined that the non-reproducible line data is found.

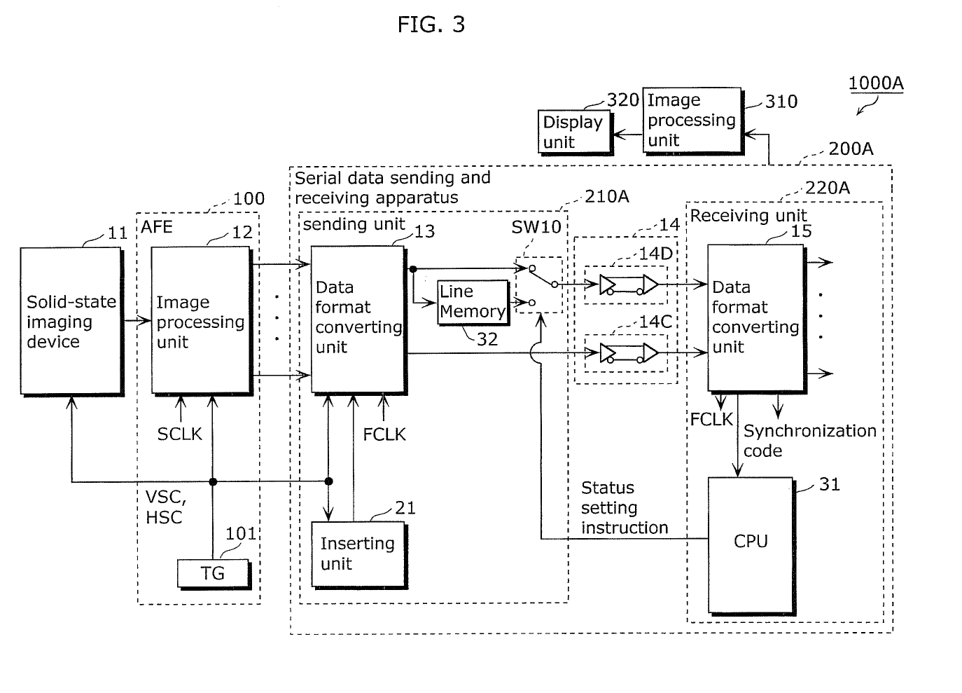

FIG. 3 shows a structure of a solid-state imaging apparatus 1000A according to Embodiment 2.

The solid-state imaging apparatus 1000A is a digital camera such as a digital still camera or a digital video camera.

The comparison shows that the solid-state imaging apparatus 1000A in FIG. 3A differs from the solid-state imaging apparatus 1000 in FIG. 1 in that the solid-state imaging apparatus 1000A includes a serial data sending and receiving apparatus 200A instead of the serial data sending and receiving apparatus 200. Other part of the solid-state imaging apparatus 1000A is similar to that of the solid-state imaging apparatus 1000. Thus, the details thereof shall not be repeated.

The comparison shows that the serial data sending and receiving apparatus 200A differs from the serial data sending and receiving apparatus 200 in FIG. 1 in that the serial data sending and receiving apparatus 200A includes a sending unit 210A instead of the sending unit 210, and a receiving unit 220A instead of the receiving unit 220. Other part of the serial data sending and receiving apparatus 200A is similar to that of the serial data sending and receiving apparatus 200. Thus, the details thereof shall not be repeated.

The comparison shows that the sending unit 210A differs from the sending unit 210 in FIG. 1 in that the sending unit 210A further includes a line memory 32 and a switch SW 10. Other part of the sending unit 210A is similar to that of the sending unit 210. Thus, the details thereof shall not be repeated.

The line memory 32 is capable of storing one piece of line data.

In response to an instruction from outside, the switch SW 10 switches between a first connection state and a second connection state. In the first connection state, the data format converting unit 13 and the transmission path 14D are electrically connected with each other. In the second connection state, the line memory 32 and the transmission path 14D are electrically connected with each other. The regular state of the switch SW 10 is the first connection state.

The data format converting unit 13 is electrically connected to each of the switch SW 10 and the line memory 32.

When the inserting unit 21 carries out the processing described in Embodiment 1, the data format converting unit 13 sends the information-inserted serial image data to the switch SW 10 and the line memory 32 for each piece of line data corresponding to one of the rows in FIG. 2B.

It is noted that when the inserting unit 21 carries out the processing described in the modification according to Embodiment 1, the data format converting unit 13 sends the alternatively-information-inserted serial image data to the switch SW 10 and to the line memory 32 for each piece of line data corresponding to one of the rows in FIG. 2B.

The line memory 32 receives line data representing part of the information-inserted serial image data or the alternatively-information-inserted serial image data, and stores the received data. When receiving new line data with other line data stored, the line memory 32 stores the new line data. In other words, the line memory 32 holds the line data until the line memory 32 receives new line data.

The switch SW 10 uses the transmission path 14D to send the data format converting unit 15 the received information-inserted serial image data or the alternatively-information-inserted serial image data for each piece of line data corresponding to one of the rows in FIG. 2B.

The comparison shows that the receiving unit 220A differs from the receiving unit 220 in FIG. 1 in that the receiving unit 220A includes a central processing unit (CPU) 31. Other part of the sending unit 220A is similar to that of the sending unit 220. Thus, the details thereof shall not be repeated.

The data format converting unit 15 carries out determination processing described in Embodiment 1. When the data format converting unit 15 determines that non-reproducible line data is found in the determination processing, the data format converting unit 15 sends the CPU 31 non-reproducible line presence information. The non-reproducible line presence information informs that the non-reproducible line data is present.

Moreover, when the inserting unit 21 carries out the processing described in the modification according to Embodiment 1, the data format converting unit 15 carries out the determination processing “A” described in the modification according to Embodiment 1. When the data format converting unit 15 determines that non-reproducible line data is found in the determination processing “A”, the data format converting unit 15 sends the CPU 31 the non-reproducible line presence information.

The CPU 31 receives the non-reproducible line presence information to recognize the presence of the non-reproducible line data. It is noted that the reception of the non-reproducible line presence information is carried out by the interrupt handling and the polling.

In response to the reception of the non-reproducible line presence information, the CPU 31 sends switch SW 10 a status setting instruction for setting the state of the switch SW 10 to the second connection state.

Upon receiving the status setting instruction, the switch SW 10 switches the state of the switch SW 10 to the second connection state. Hence, the line data corresponding to the non-reproducible line data and stored in the line memory 32 is sent (resent) to the data format converting unit 15 via the transmission path 14D.

In other words, the status setting instruction is used for resending the data format converting unit 15 the line data corresponding to the non-reproducible line data.

It is noted that the timing with the CPU 31 sending the status setting instruction is the timing in the horizontal blanking interval as an interval between two neighboring pieces of line data.

As described above, when the non-reproducible line data is found in Embodiment 2, the CPU 31 resends the data format converting unit 15 the line data corresponding to the non-reproducible line data. In other words, the CPU 31 is a resending instructing unit which gives sending unit 210A the status setting instruction for resending the receiving unit 220A the line data corresponding to the non-reproducible line data.

Thus, even though the non-reproducible line data develops due to the noise and the like, the line data corresponding to the non-reproducible line data can be obtained. Hence, the data format converting unit 15 can reproduce (decode) a normal image from the received data. In other words, missing part of the reproduced image due to the noise can be recovered.

It is noted that the line memory 32 may be a memory for storing the information-inserted serial image data for one frame or the alternately-information-inserted serial image data. Here, when it is determined that the non-reproducible line data is found, the CPU 31 sends the status setting instruction to the switch SW 10. Hence, the information-inserted serial image data or the alternatively-information-inserted serial image data stored in the line memory 32 is sent (resent) to the data format converting unit 15 via the transmission path 14D.

It is noted that some or all of the solid-state imaging device 11, the image processing unit 12, the data format converting unit 13, the transmission paths 14D and 14C, the data format converting unit 15, the inserting unit 21, the switch SW 10, and the CPU 31 may be formed in one LSI chip.

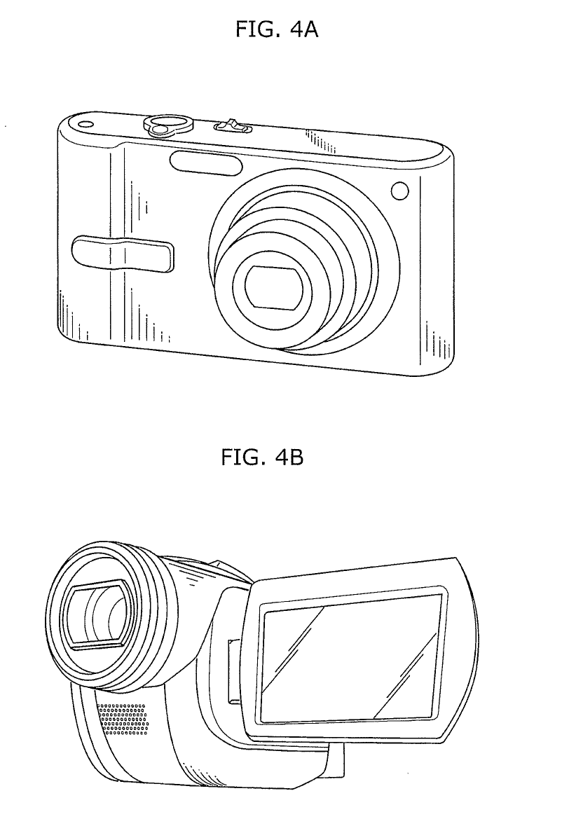

FIG. 4A shows an external view of the solid-state imaging apparatuses 1000 and 1000A as a digital still camera. FIG. 4B shows an external view of the solid-state imaging apparatuses 1000 and 1000A as a digital video camera.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

Furthermore, some or all of the constituent features included in the serial data sending and receiving apparatus may be implemented in hardware. Moreover, some or all of the constituent features included in the serial data sending and receiving apparatus may be a program module executed on a CPU.

In addition, some or all of the constituent features included in the serial data sending and receiving apparatus may be may be configured from a single System-LSI (Large-Scale Integration). The System-LSI is a super-multi-function LSI manufactured by integrating constituent units on one chip, and is specifically a computer system configured by including a microprocessor, a ROM (Read Only Memory), a RAM (Random Access Memory), and so on.

The present invention may be provided as a serial data sending and receiving method implementing, as steps, operations of the characteristic units included in the serial data sending and receiving apparatus. The present invention may be provided as a program to cause a computer to execute each of the steps included in the serial data sending and receiving method. The present invention may be provided as a computer-readable storage medium which stores the program. The program may be distributed via a transmission medium such as the Internet.

The embodiments disclosed above are meant to be illustrative only and not limiting as to the scope of the invention, which is to be given the full breadth of the appended claims and all equivalents thereof.

### INDUSTRIAL APPLICABILITY

The present invention is applicable to solid-state imaging apparatuses, such as a digital still camera and digital video camera which are required to transmit serial-format image data at a high speed.

What is claimed is:

1. A serial data sending and receiving apparatus comprising:
a sending unit configured to send serial-format data via a transmission path; and
a receiving unit configured to receive the serial-format data via the transmission path,
wherein said sending unit includes a data format converting unit configured to convert parallel-format image data including a plurality of pieces of line data into serial image data which is serial-format image data,
the serial image data includes the pieces of the line data which are successively arranged,
said sending unit further includes an inserting unit configured to carry out iterative insertion of inserting, between each of adjacent pairs of the line data, a piece of determining information for determining whether or not non-reproducible line data is found, each of the adjacent pairs of the line data found in the successively arranged pieces of the line data included in the serial image data,
by said inserting unit carrying out the repetitive inserting processing, said data format converting unit is configured to (i) obtain information-inserted serial image data which is serial-format data, and has each of a plurality of pieces of determining information inserted into the serial image data, and (ii) send the obtained information-inserted serial image data to said receiving unit via the transmission path, and
said receiving unit includes a determining unit configured to sequentially detect the pieces of the determining information from the information-inserted serial image data received from the transmission path, and to determine whether or not the non-reproducible line data is found according to at least part of the detected pieces of the determining information.

2. The serial data sending and receiving apparatus according to claim 1,
wherein each piece of determining information indicates a value for specifying corresponding one of the pieces of the line data, and
said determining unit is configured to (i) sequentially detect the pieces of the determining information from the information-inserted serial image data, and (ii) compare a value indicated in a detected most recent piece of the determining information with a value indicated in a piece of the determining information detected immediately before the most recent piece of the determining information to determine whether or not the non-reproducible line data is found.

3. The serial data sending and receiving apparatus according to claim 1,
wherein said inserting unit is configured to carry out the iterative insertion for (i) inserting first determining information as the determining information between an n-th (n: positive integer) adjacent pair of the line data in the successively arranged pieces of the line data, and (ii) inserting second determining information, as the determining information, between an n+1-th adjacent pair of the line data in the successively arranged pieces of the line data.

4. The serial data sending and receiving apparatus according to claim 3,
wherein said determining unit included in said receiving unit is configured to (i) sequentially detect the pieces of the determining information from the information-inserted serial image data, and, in the case where detected and successive two of the pieces of the determining information are both one of the first determining information and the second determining information, and (ii) determine that the non-reproducible line data is found.

5. The serial data sending and receiving apparatus according to claim 3,
wherein at least one of the first determining information and the second determining information is indicated in one-bit data.

6. The serial data sending and receiving apparatus according to claim 1, further comprising
a resending instructing unit configured to give, in the case where said determining unit determines that the non-reproducible line data is found, said sending unit an instruction for re-sending, to said receiving unit, line data corresponding to the non-reproducible line data.

7. The serial data sending and receiving apparatus according to claim 1,
wherein the transmission path transmits data on a Low Voltage Differential Signaling (LVDS)-based signal.

8. A digital camera comprising:
said serial data sending and receiving apparatus according to claim 1;
an imaging device which obtains an image signal by imaging an object;
an analog front-end unit configured to obtain image data by converting the image signal obtained by said imaging device into digital data;
an image processing unit configured to process the image data; and
a display unit configured to display an image which is based on the image data processed by said image processing unit,
wherein said serial data sending and receiving apparatus is configured to obtain the image data from said analog front-end unit, and send the obtained image data to said image processing unit via said sending unit and said receiving unit.
